(19) United States
(12) Patent Application Publication
(10) Pub. No.: US 2017/0292814 A1
(43) Pub. Date: Oct. 12, 2017

(54) RETRACTABLE AIMING SYSTEM

(71) Applicant: Cockerill Maintenance & Ingenierie S.A., Seraing (BE)

(72) Inventors: Vincent Dumont, Vise (BE); Philippe Delvaux, Beaufays (BE)

(21) Appl. No.: 15/508,150

(22) PCT Filed: Aug. 31, 2015
(86) PCT No.: PCT/EP2015/069823

§ 371 Date: Mar. 2, 2017

(30) Foreign Application Priority Data
Sep. 4, 2014 (BE) 2014/667

(51) Int. Cl. F41G 11/00; F16M 11/04; F16M 11/18; F41H 7/02

(52) U.S. Cl. CPC F41G 11/00; F41H 7/02; F16M 11/043; F16M 11/18

(57) ABSTRACT

A retractable aiming system for equipping a military land vehicle, which system has a sight unit and a retractable mechanism that ensures, during use, the movement of the sight unit between two positions, a first position being outside the vehicle and a second position being inside the vehicle.

### BACKGROUND

This application is a U.S. national stage application under 35 U.S.C. §371 of International Application No. PCT/EP2015/069823, filed on Aug. 31, 2015, and claims benefit to Belgian Patent Application No. 2014/667, filed on Sep. 4, 2014. The International Application was published in French on Mar. 10, 2016, as WO 2016/034528 A1 under PCT Article 21(2).

### FIELD

The present invention relates to the field of sight systems for weapons aboard military vehicles.

### BACKGROUND

The sight systems for armored vehicles and battle tanks comprise an optical unit which, during operation, is positioned outside the vehicle as shown in FIG. 1 of document EP 2 458 244 and FIG. 3 of document EP 2 669 617. The optical unit protrudes and is considerably taller than the turret of the military vehicle, which is problematic when the vehicle is transported by airplane and by train.

Currently, the problem is solved by disassembling the optical unit before transportation and reassembling it afterwards, which is a lengthy and tedious operation.

Consequently, the CT-CVTM turret comprises a retractable sight system. However, the drawback of the existing system is that the tools are bulky in the confined environment of the turret when the optical unit is in the deployed position. Due to its fixed nature, either the tooling is left in place and is in the way, or it is disassembled and causes lost time.

The device of document U.S. Pat. No. 4,161,352 has the same drawback. That document discloses a monitoring device of the periscope type that can be deployed outside a vehicle using a screw and nut system. The device comprises the screw, which is secured to the optical unit mounted to move in translation, and the nut, which is secured to a chassis that occupies the inner volume of the vehicle. During outside deployment, the optical unit moves vertically, leaving the inner volume of the vehicle occupied by the chassis.

In the case of a turret, as opposed to a simple surveillance vehicle as described in document U.S. Pat. No. 4,161,352, the available inner volume is particularly critical due to the quantity of equipment. Furthermore, the system to be deployed is a sight system that comprises many sensors (optical, thermal, laser, gyroscope, etc.) and not a simple periscope, as in the aforementioned document. Given its complexity, the volume occupied by the sight system is particularly significant, hence the need to be able to deploy it without leaving any bulky structure inside the turret. Next, it is necessary that the system can be quickly repositioned in the deployed position without any adjustment required to ensure the sight performance.

### SUMMARY

An aspect of the invention provides a retractable sight system, configured to equip a land military vehicle, the system comprising: an optical unit; and a translation mechanism configured to provide, in use, translation movement of the optical unit between a first position and a second position, wherein the first position is outside the vehicle, wherein the second position is inside the vehicle. The translation mechanism is retractable so as to reduce bulk inside the vehicle when the optical unit is in the first position. The movement of the optical unit between the second position and the first position allows, along a translation axis, reduction of a length occupied by the sight system within the vehicle by more than 80%.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 the sight system provided with the retracting mechanism according to the invention with the optical unit in the retracted position;

FIG. 2 a partial view of the upper part of the vehicle, and more specifically of the roof of the turret of the vehicle, with that same optical unit in the retracted position inside the vehicle;

FIG. 3 the sight system provided with the retracting mechanism according to the invention with the optical unit in the deployed position, the lens being shown in broken lines;

FIG. 4 a partial view of the upper part of the vehicle, and more specifically of the roof of the turret of the vehicle, with that same optical unit in the position deployed outside the vehicle; and

FIG. 5 diagrammatically the volume gain (ΔV) inside the vehicle when the optical unit is in the deployed position, as well as the correct positioning of the sight system relative to the three axes and its parallelism relative to the line of fire.

### DETAILED DESCRIPTION

An aspect of the present invention provides a sight system that is suitable for avoiding the assembly/disassembly operation of the optical unit during transportation of the vehicle.

An aspect of the invention relates to sight systems for weapons aboard military vehicles, more particularly a retractable sight system and to the vehicle equipped with that sight system.

More specifically, an aspect of the present invention provides a retractable sight system where the volume occupied in the turret by the mechanism is reduced when the optical unit is deployed.

An aspect of the present invention provides a system allowing to quickly and easily place the optical unit in the deployed or retracted position.

Consequently, an aspect of the present invention provides a retractable sight system with maintained sight performance after the optical unit is repositioned in the deployed position.

An aspect of the present invention relates to a retractable sight system designed to equip a land military vehicle, said system comprising an optical unit and a retractable mechanism ensuring the movement of the optical unit between two positions, a first position being outside the vehicle and a second position being inside the vehicle.

An aspect of the present invention relates to a retractable sight system designed to equip a land military vehicle provided with a turret, said system comprising an optical unit and a retractable mechanism ensuring movement of the optical unit between two positions, a first position being outside the turret and a second position being inside the turret.

According to specific embodiments of the invention, the sight system comprises at least one or several suitable combinations of the following features:
the retractable sight system is free of any chassis that restricts the inner volume of the vehicle when the optical unit is in the first position;
the movement of the optical unit between the second position and the first position allows, along the translation axis, to reduce the length occupied within the vehicle by more than 80%, and preferably more than 90%;
the retractable mechanism is a scissor mechanism;
it comprises a movably-assembled support on which the optical unit rests;
the support comprises a planar base also called base plate;
the scissor mechanism comprises branches respectively situated on either side of the optical unit, said branches being coupled at one end to the base plate and at the other end to the structure on which the base plate is positioned when the optical unit is in the first position;
it comprises several constant-pressure springs serving as a counterweight to the weight of the sight system;
the springs are positioned on either side of the optical unit and connect the base plate to the structure;
it comprises a repositioning mechanism that ensures, at the end of the movement toward the first position, a precise placement of the base plate on the structure;
the repositioning mechanism comprises fingers positioned on the support and notches secured to the structure, said fingers cooperating with the notches to ensure the parallelism of the system relative to the axis of a cannon equipping the vehicle;
it comprises means for locking the sight system in the first operational position;
said means comprise quick-tightening nuts positioned on the base plate and cooperating with rods secured to the structure;
the base plate is provided with a handle to facilitate handling of the optical unit;
the structure is designed to be mounted on an inner wall of the shell of the vehicle;
the structure is an interface plate having a plane parallel relative to the axis of the cannon equipping the vehicle;
the structure is an inner wall of the shell of the vehicle;
it comprises sealing gaskets ensuring tightness of the system when the optical unit is in the first position;
it comprises a first seal placed on the upper end of the support and designed to be positioned inside the vehicle on the structure when the optical unit is in the first position, and comprising a second seal designed to be placed outside the vehicle on a perimeter of an opening formed in the shell to allow the passage of the optical unit;
it comprises an interface base positioned between the support and the optical unit and allowing to place different types of optical units;
the system is configured so that, in the first position, the entire optical unit is outside the vehicle and in the second position, the entire optical unit is inside the vehicle;
it is further configured so that, in the first position, the interface base is positioned outside the vehicle.

An aspect of the present invention also relates to the land military vehicle comprising the retractable sight system described above.

An aspect of the present invention relates to a retractable sight system designed to equip a military vehicle, and more specifically, a land military vehicle such as an armoured vehicle or a tank. According to an aspect of the invention, the sight system is provided with a retracting mechanism that ensures that the optical unit can be retracted inside the vehicle, and conversely, deployed outside the vehicle.

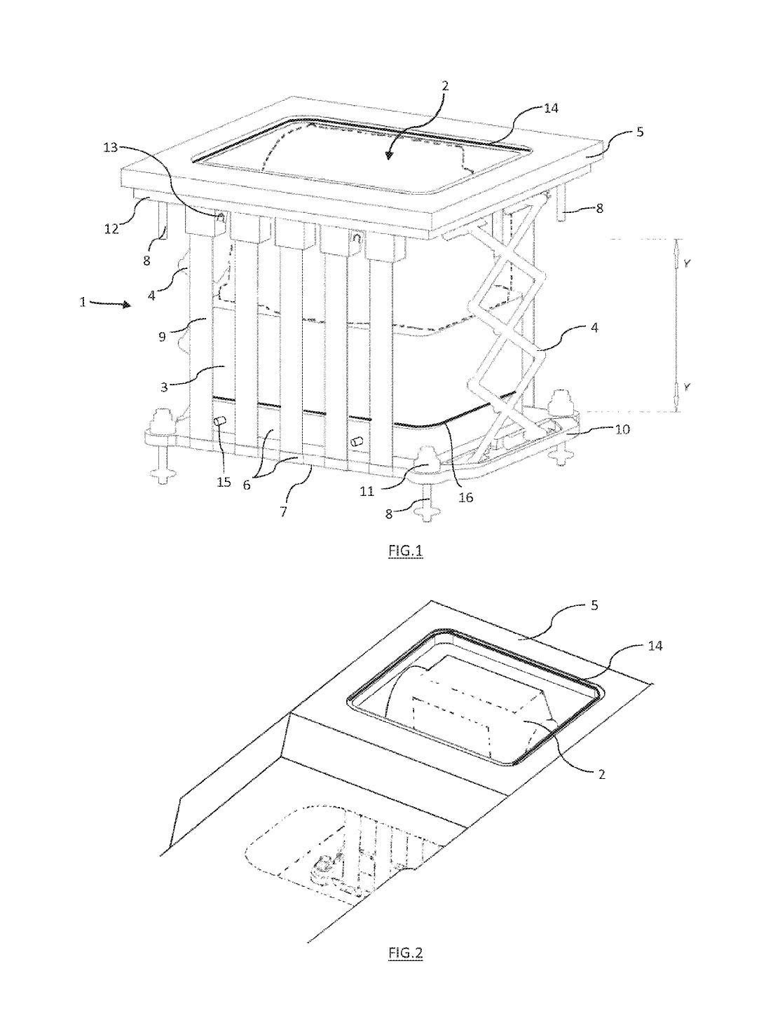

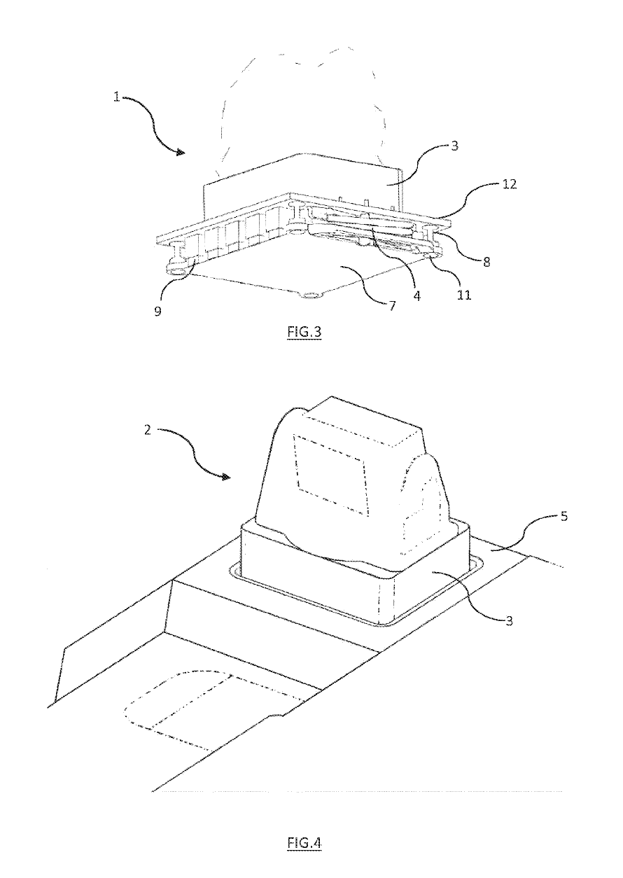

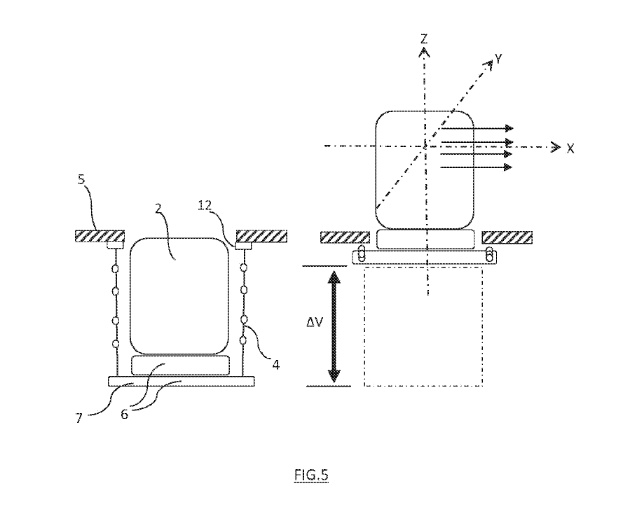

The sight system 1 according to the invention is shown in FIG. 1 in the retracted position. A more expansive view with part of the roof of the turret of the vehicle is shown in FIG. 2. The sight system is shown in the deployed position in FIG. 3, also with an enlarged view in FIG. 4.

The sight system 1 comprises an optical unit 2 resting on interface base 3 that is sized based on the vehicle and the lens. This base 3 is in turn mounted on a support 6 provided with a planar base that will be described as base plate 7, topped by a part with a shape that is substantially complementary to that of the interface base. The support 6 is mounted to move in translation and moves vertically owing to a retractable mechanism. By “retractable mechanism” is meant a mechanism that can contract, or in other words be compressed, to free space within the vehicle. For example and as an illustration, it may involve a scissor-type mechanism 4. Preferably, the scissor mechanism 4 is provided with branches respectively positioned on either side of the optical unit 2. The branches of the scissor mechanism 4 are secured at their lower ends to the base plate 7 of the support. At their upper ends, the branches of the scissor mechanism 4 are either directly secured to the inner wall of the shell 5 of the vehicle or secured to an interface plate 12 mounted on the inner wall of the shell 5 of the vehicle. As opposed to the support that is mounted movably, the interface plate 12 or the shell 5 will be described as a fixed structure.

The sight system according to an aspect of the invention further comprises a repositioning mechanism that ensures, when the movement is completed, the precise placement of the base plate 7 on the fixed structure 12. This positioning mechanism comprises fingers 15 positioned on the support 6, and more specifically on its upper part, cooperating with notches 13 arranged in the fixed structure 12 or in tongues that are secured to the fixed structure as shown in FIG. 1.

The sight system according to an aspect of the invention also comprises means for fixing the base plate 7 to the fixed structure 12 when the optical unit 2 is deployed, i.e., when the base plate 7 is in the upper position as shown in FIGS. 3 and 4. For example, the base plate 7 may be locked in the upper position on the fixed structure 12 with quick-tightening nuts 11 by means of four references in the form of rods 8 ensuring securing of the system.

The sight system also comprises a counterweight in the form of constant-pressure springs 9, which offsets the weight of the lens. This allows to cancel the weight of the lens to be moved independently from the path travelled, in the lowering direction, but also the raising direction of the lens. The springs 9 are distributed on either side of the optical unit on faces thereof that are not those where the branches of the scissor mechanism are positioned. They are fixed at one end to the base plate 7 and at the other end to the fixed structure 12. Each constant-pressure spring may react up to 15 kg, for example. The number of springs therefore depends on the weight of the lens used. In the illustrated example, five springs are positioned on either side of the optical unit.

According to an aspect of the invention, the tightness is ensured by a first seal 14 positioned on the outer wall of the shell 5, and more specifically, in a slot arranged on the perimeter of the opening formed in the shell for the passage of the optical unit. It is also ensured by a second seal 16 positioned at the upper end of the support 6 at the junction with the interface base 3.

Lastly, it will be specified that the base plate 7 comprises a handle 10 to facilitate the handling of the device.

During operation, the optical unit 2 and the interface base 3 are positioned outside the turret of the vehicle, the optical unit being locked in the deployed position using tightening nuts 11. When the vehicle is not operational, the nuts can be unscrewed to allow the retraction of the optical unit inside the turret of the vehicle, abrupt lowering of the optical unit being avoided owing to the springs. The optical unit will easily be repositioned in the operational position by applying a force on the base plate, the vertical movement being ensured by the scissor mechanism and the repositioning mechanism.

Owing to the spring system, the operating time is minimized, approximately a few minutes, relative to the current system that requires the assembly and disassembly and takes several hours. The vehicle is then practically operational as soon as it leaves the airplane or train.

In addition to being quick, setting-up is secure and easy, requiring only one person.

The vehicle equipped with a retractable sight system can be easily transported on any type of airplane and train.

Owing to the retractable mechanism, the bulk inside the vehicle or the turret is limited when the optical unit is in the final raised position, as diagrammed in FIG. 5. Thus, the compression of the scissor mechanism allows to reduce the height occupied in the turret by the sight system by more than 80%, and preferably more than 90%. Hence, the freed space may be reallocated to other mechanisms during operation.

The guiding of the device allows to ensure the lowering and raising of the optical unit along a vertical axis.

A counterweight is created to meet the need for careful and secure handling required by the weight of the sight system (+/−100 kg) and its fragility.

According to an aspect of the invention, the repositioning system and the complete flatness of the base of the support make it possible to ensure the parallelism of the sight system relative to the line of fire, and thereby to guarantee the performance of the sight system when the optical unit is in the operational position, as illustrated in FIG. 5. Furthermore, the precision of the localization in the retracted or deployed position allows to guarantee good tightness owing to the seals. This is particularly important to ensure the operation under unfavorable weather conditions and for protection in case of NBC chemical attacks.

The interface base allows to use various panoramic lenses.

The retractable sight system according to an aspect of the invention further has the following advantages:
no high-precision parts to be ordered,
smaller enclosure relative to the mechanism existing in the CT-CVTM turret,
possible subsequent application of constant-pressure spring modules.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### KEY

(1) Sight system
(2) Optical unit
(3) Upper interface base
(4) Scissor mechanism
(5) Vehicle shell
(6) Support
(7) Planar base, also called base plate of the support
(8) Fastening rod
(9) Spring
(10) Handle
(11) Nut
(12) Interface plate, also called fixed structure or fixed plate, which may be attached to the shell of the vehicle or machined in the shell of the vehicle
(13) Repositioning notch
(14) Outer sealing gasket
(15) Repositioning finger
(16) Inner sealing gasket

1. A retractable sight system configured to equip a land military vehicle, the system comprising:
an optical unit; and
a translation mechanism configured to provide, in use, translation movement of the optical unit between a first position and a second position
wherein the first position is outside the vehicle,
wherein the second position is inside the vehicle,
wherein the translation mechanism is retractable so as to reduce bulk inside the vehicle when the optical unit is in the first position, and
wherein the movement of the optical unit between the second position and the first position allows, along a translation axis, reduction of a length occupied by the sight system within the vehicle by more than 80%.

2. The system of claim 1, wherein the translation mechanism is a scissor mechanism.

3. The system of claim 1, wherein the reduction of the length occupied by the sight system within the vehicle is more than 90%.

4. The system of claim 1, further comprising:
a support, mounted movably, on which the optical unit rests,
wherein the support includes a planar base that is a base plate.

5. The system of claim 2, further comprising:
a support, mounted movably, on which the optical unit rests,
wherein the support includes a planar base that is a base plate,
wherein the scissor mechanism includes a first and a second branch, respectively situated on either side of the optical unit, and
wherein the branches are coupled at a first end to the base plate and at a second end to a structure on which the base plate is positioned when the optical unit is in the first position.

6. The system of claim 1, further comprising:
a first and a second constant-pressure spring serving as a counterweight to a weight of the sight system.

7. The system of claim 5, further comprising:
a first and a second constant-pressure spring serving as a counterweight to a weight of the sight system,
wherein the springs are positioned on either side of the optical unit and connect a base plate to the structure.

8. The system of claim 5, further comprising:
a repositioning mechanism configured to provide, an end of the movement toward the first position, a precise placement of the base plate on the structure.

9. The system of claim 8, wherein the repositioning mechanism includes fingers, positioned on the support, and notches secured to the structure,
wherein the fingers are configured to cooperate with the notches to provide parallelism of the system relative to a cannon axis of the vehicle.

10. The system of claim 5, further comprising:
a lock configured to lock the sight system in the first position,
wherein the lock includes quick-tightening nuts positioned on the base plate and cooperating with rods that are secured to the structure.

11. The system of claim 5, wherein the structure is an interface plate designed to be mounted on an inner wall of a shell of the vehicle,
wherein the interface plate has a parallel plane relative to an axis of a cannon of the vehicle.

12. The system of claim 5, Wherein the structure is an inner wall of a shell of the vehicle.

13. The system of claim 5, further comprising:
sealing gaskets configured to provide sealing of the system when the optical unit is in the first position, the sealing gaskets including:
a first seal, placed on an upper end of the support, is configured to be positioned on the structure inside the vehicle when the optical unit is in the first position, and
a second seal configured to be placed outside the vehicle on a perimeter of an opening formed in the shell to allow passage of the optical unit.

14. The system of claim 5, further comprising:
an interface base, positioned between the support and the optical unit, configured to allow placement of different types of optical units on the interface base.

15. A land military vehicle, comprising the system of claim 1.
